(19) United States
(12) Patent Application Publication
(10) Pub. No.: US 2019/0078517 A1
(43) Pub. Date: Mar. 14, 2019

(54) METHOD AND SYSTEM FOR DIRECTING FUEL FLOW TO AN ENGINE

(71) Applicant: PRATT & WHITNEY CANADA CORP., Longueuil (CA)

(72) Inventors: Jeremie HEBERT, Napierville (CA); Sylvain LAMARRE, Boucherville (CA); Nicolas DES ROCHES-DIONNE, Montreal (CA)

(21) Appl. No.: 15/700,381

(22) Filed: Sep. 11, 2017

(51) Int. Cl. F02C 9/46

(52) U.S. Cl. CPC F02C 9/46; F02C 9/28

(57) ABSTRACT

Systems and methods for directing fuel flow to an engine when the engine is in an electronic manual override mode are described herein. In accordance with an aspect, a commanded fuel flow to the engine is determined from a fuel schedule based on the position on an engine control lever; a limit is applied on the commanded fuel flow when the commanded fuel flow exceeds a maximum fuel flow threshold; and fuel flow is directed to the engine based on the commanded fuel flow.

### TECHNICAL FIELD

The present disclosure relates generally to engine control, and, more particularly, to directing fuel flow to a gas turbine engine.

### BACKGROUND OF THE ART

Single hydro-mechanically controlled turbine engines typically feature a manual override mode. This mode is provided in case of mechanical failure in the control system of the engine. It allows a pilot to complete a flight following such an event. In this mode, the pilot may directly modulate the fuel flow sent to the engine. It is the pilot's responsibility to ensure that engine limits as well as maximum temperature of the engine is respected. If the pilot does not modulate the fuel flow in an appropriate manner this may result in surge or flameout of the engine.

Some electronically controlled engines are provided without a manual override mode, as they have an additional level of redundancy incorporated already. However, there is a need for including a manual override mode even in such engines.

### SUMMARY

In one aspect, there is provided a method for directing fuel flow to an engine for an aircraft when the engine is in an electronic manual override mode. The method comprises determining a commanded fuel flow to the engine from a fuel schedule based on a position of an engine control lever for controlling the engine; applying a limit on the commanded fuel flow when the commanded fuel flow exceeds a maximum fuel flow threshold; and directing fuel flow to the engine based on the commanded fuel flow while maintaining fuel flow within the limit.

In another aspect, there is provided a system for directing fuel flow to an engine for an aircraft when the engine is in an electronic manual override mode. The system comprises a processing unit and a non-transitory computer-readable memory having stored thereon program instructions executable by the processing unit. The instructions are executable for determining a commanded fuel flow to the engine from a fuel schedule based on a position of an engine control lever for controlling the engine; applying a limit on the commanded fuel flow when the commanded fuel flow exceeds a maximum fuel flow threshold; and directing fuel flow to the engine based on the commanded fuel flow while maintaining fuel flow within the limit.

In yet another aspect, there is provided a method for directing fuel flow to an engine for an aircraft when the engine is in an electronic manual override mode. The method comprises determining a commanded fuel flow to the engine based on a position of an engine control lever for controlling the engine; monitoring a temperature of the engine; applying a limit on the commanded fuel flow based on the temperature of the engine to maintain the temperature of the engine within a maximum temperature threshold; and directing fuel flow to the engine based on the commanded fuel flow while maintaining fuel flow within the limit.

In another aspect, there is provided a system for directing fuel flow to an engine for an aircraft when the engine is in an electronic manual override mode. The system comprises a processing unit and a non-transitory computer-readable memory having stored thereon program instructions executable by the processing unit. The instructions are executable for determining a commanded fuel flow to the engine based on a position of an engine control lever for controlling the engine; monitoring a temperature of the engine; applying a limit on the commanded fuel flow based on the temperature of the engine to maintain the temperature of the engine within a maximum temperature threshold; and directing fuel flow to the engine based on the commanded fuel flow while maintaining fuel flow within the limit.

### DESCRIPTION OF THE DRAWINGS

Reference is now made to the accompanying figures in which:

FIG. 1 is a schematic cross-sectional view of an example engine of an aircraft;

FIG. 2 is a flowchart illustrating a first example method for directing fuel flow to an engine in accordance with an embodiment;

FIG. 3A is an example graphical representation of a fuel schedule;

FIG. 3B is an example graphical representation of fuel schedules for different altitudes;

FIG. 4 is a flowchart illustrating a second example method for directing fuel flow to an engine in accordance with an embodiment;

FIG. 5 is a schematic diagram of an example computing system for implementing the method of FIG. 2 and/or FIG. 4 in accordance with an embodiment; and

FIG. 6 is a schematic diagram of the example computing system and the example engine in accordance with an embodiment.

It will be noted that throughout the appended drawings, like features are identified by like reference numerals.

### DETAILED DESCRIPTION

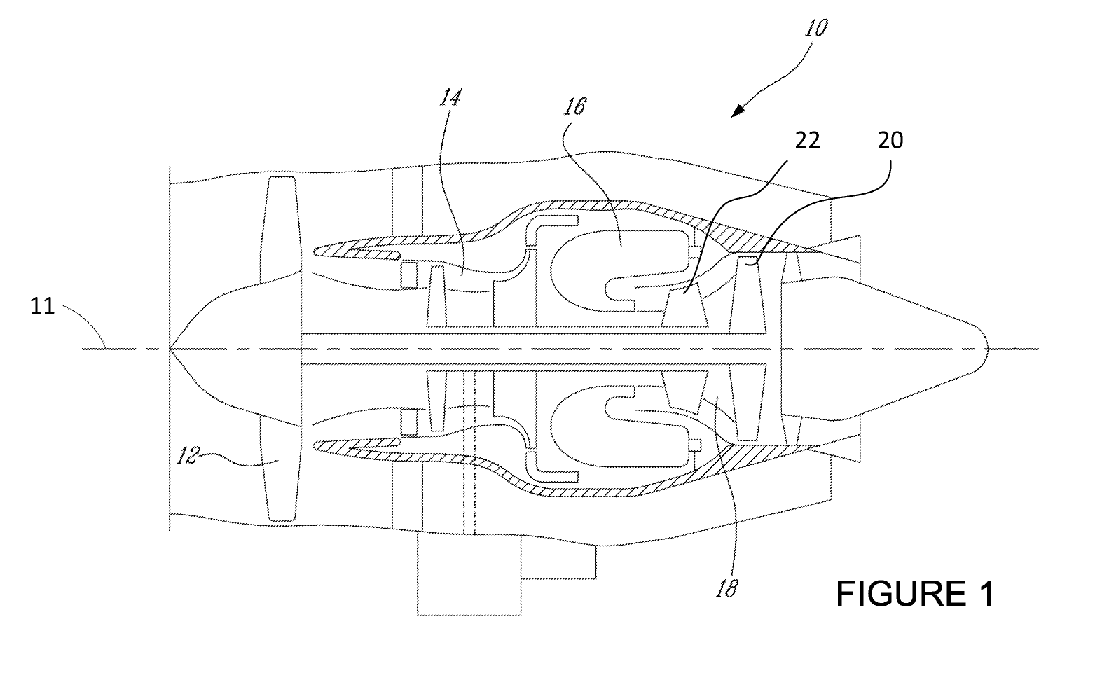

FIG. 1 illustrates a gas turbine engine 10 for which fuel flow may be directed using the systems and methods described herein. Note that while engine 10 is a turbofan engine, the methods and systems for directing fuel to the engine may be applicable to turboprop, turboshaft, and other types of gas turbine engines.

Engine 10 generally comprises in serial flow communication: a fan 12 through which ambient air is propelled, a compressor section 14 for pressurizing the air, a combustor 16 in which the compressed air is mixed with fuel and ignited for generating an annular stream of hot combustion gases, and a turbine section 18 for extracting energy from the combustion gases. Axis 11 defines an axial direction of the engine 10.

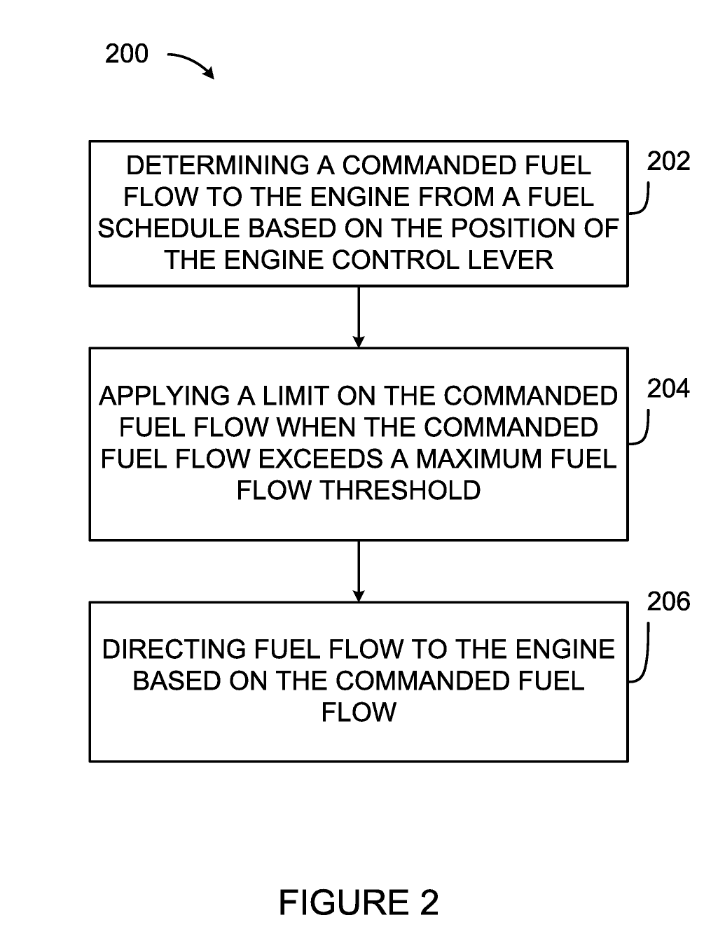

With reference to FIG. 2, there is shown a flowchart illustrating a first example method 200 for directing fuel flow to an engine, such as engine 10 of FIG. 1. While the method 200 is described herein with reference to the engine 10 of FIG. 1, this is for example purposes. The method 200 may be applied to other types of engines depending on practical implementations.

The method 200 is applicable for directing fuel flow to the engine 10 when the engine 10 is in an electronic manual override mode. The electronic manual override mode refers to when a secondary mechanism is used for directing fuel flow to the engine 10, instead of a primary mechanism that is conventionally used for directing fuel flow to the engine 10.

At step 202, a commanded fuel flow to the engine 10 is determined from a fuel schedule based on a position of an engine control lever used for controlling the engine 10. The engine control lever may comprise a thrust lever, a power lever and/or any other suitable mechanism for controlling the engine 10. The position of the engine control lever may be defined by an angle, such as a power lever angle (PLA). The position of the engine control lever may be determined using position sensors or other position determining mechanisms.

The position of the engine control lever used for controlling the engine 10 is obtained, either dynamically in real time when needed or regularly/irregularly in accordance with any predetermined time interval. The position of the engine control lever may be actively retrieved, or may be passively received. For example, the position of the engine control lever may be retrieved and/or received from a measuring device comprising one or more sensors for measuring the position of the engine control lever. By way of another example, the position of the engine control lever may be retrieved and/or received from a control system or aircraft/engine computer. In some embodiments, the position of the engine control lever is obtained via existing components as part of engine control and/or operation. In some embodiments, step 202 comprises triggering measurement of the position of the engine control lever whenever method 200 is initiated.

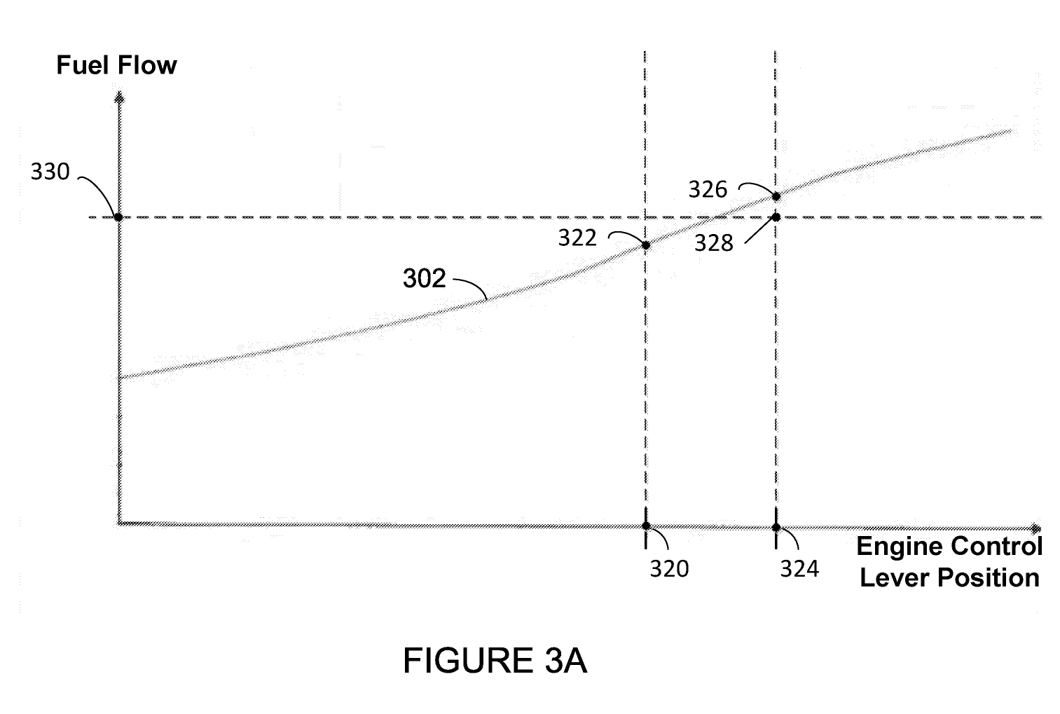

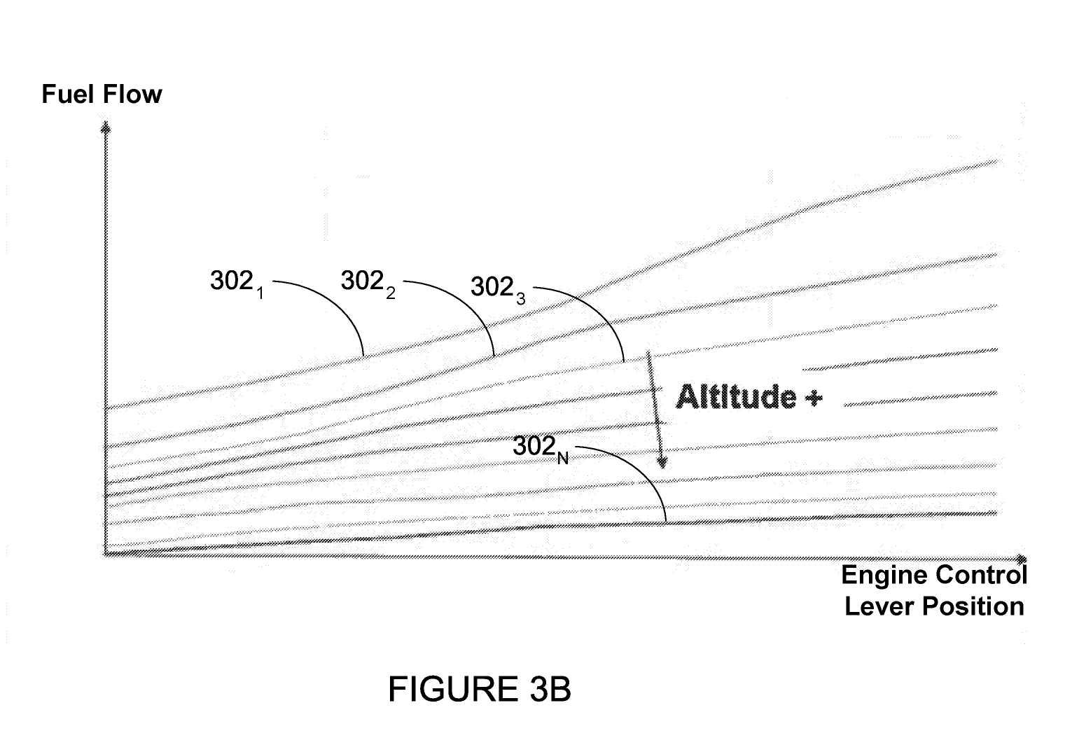

The fuel schedule may be any suitable equation, lookup table, and the like, to determine the commanded fuel flow from the position of the engine control lever. With additional reference to FIG. 3A, an example fuel schedule 302 is illustrated. As shown, the fuel schedule 302 provides fuel flow as a function of the position of the engine control lever. For example, if the engine control lever is set at a first position 320, a first commanded fuel flow 322 is obtained from the fuel schedule 302 corresponding to the first position 320. By way of another example, if the engine control lever is set at a second position 324, a second commanded fuel flow 326 is obtained from the fuel schedule 302 corresponding to the second position 324. Accordingly, in this example, the commanded fuel flow is obtained from a value of the fuel schedule 302 corresponding to the position of the engine control lever.

Referring back to FIG. 2, at step 204, a limit is applied on the commanded fuel flow when the commanded fuel flow exceeds a maximum fuel flow threshold.

With additional reference to FIG. 3A, an example maximum fuel flow threshold 330 is illustrated. The commanded fuel flow is compared to the maximum fuel flow threshold 330 to determine if the commanded fuel flow exceeds the maximum fuel flow threshold 330. As illustrated in FIG. 3A, the first commanded fuel flow 322 is less than the maximum fuel flow threshold 330. Accordingly, when the engine control lever is at the first position 320, the commanded fuel flow corresponds to first commanded fuel flow 322. As illustrated in FIG. 3A, the second commanded fuel flow 326 exceeds the maximum fuel flow threshold 330. Accordingly, when the engine control lever is at the second position 324, the commanded fuel flow is set to a value 328 corresponding to the maximum fuel flow threshold 330.

Referring back to FIG. 2, at step 206, fuel flow is directed to the engine 10 based on the commanded fuel flow while maintaining fuel flow within the limit. In other words, fuel flow is directed to the engine 10 based on the commanded fuel flow without exceeding the limit. If the commanded fuel flow does not exceed the maximum fuel flow threshold 330, fuel flow is directed to the engine based on the commanded fuel flow. If the commanded fuel flow exceeds the maximum fuel flow threshold 330, fuel flow is directed to the engine based on the limit corresponding to maximum fuel flow threshold 330. The fuel flow may be directed to the engine 10 by controlling a fuel pump associated with the engine 10.

In some embodiments, the maximum fuel flow threshold 330 varies as a function of one or more operating conditions. In other words, the maximum fuel flow threshold 330 corresponds to a value that changes based on one or more operating conditions. Operating conditions refer to one or more conditions associated with the aircraft and may comprise aircraft speed, ambient conditions, engine extractions, engine temperature, any suitable operating conditions associated with the engine 10 and/or any other suitable aircraft operating conditions. Ambient conditions refer to conditions outside of the aircraft and may comprise air temperature, altitude and/or any other suitable ambient condition. Engine extractions refer to conditions placed on the engine 10 that affects the operation of the engine 10 and may comprise cabin bleed, electrical load and/or any other suitable engine extractions.

The fuel flow threshold 330 may be determined as a function of one or more operating conditions. In some embodiments, the method 200 further comprises, obtaining one or more operating conditions and determining the maximum fuel flow threshold 330 as function of the obtained one or more operating conditions. The operating conditions may be obtained by one or more measuring devices comprising one or more sensors. The operating conditions may be determined in real time when needed, or may be determined regularly/irregularly in accordance with any predetermined time interval. Operating conditions may be actively retrieved, or may be passively received. For example, one or more of altitude, ambient temperature, aircraft speed and engine extractions may be obtained and used to determine the maximum fuel flow threshold 330. In other words, the maximum fuel flow threshold 330 may be determined as a function of one parameter, two parameters, or three or more parameters.

By way of a specific and non-limiting example, an altitude of the aircraft is obtained and the maximum fuel flow threshold 330 is determined based on the altitude of the aircraft. In some embodiments, the maximum fuel flow threshold 330 is determined based on altitude and at least one additional parameter such as one or more of aircraft speed, engine temperature, air temperature, engine extractions and any other suitable operating condition. For example, altitude and aircraft speed may be used to determine the maximum fuel flow threshold. By way of another example, altitude, aircraft speed and engine extractions may be used to determine the maximum fuel flow threshold. By way of yet another example, altitude, ambient temperature, aircraft speed and engine extractions may be used to determine the maximum fuel flow threshold from a plurality of maximum fuel flow thresholds. The fuel flow threshold may be determined in any suitable manner such as by use of an equation, by use of a lookup table, by selecting from a plurality of maximum fuel flow thresholds based on one or more operating conditions and the like.

In some embodiments, the maximum fuel flow threshold 330 corresponds to a fuel flow amount occurring at a predetermined value above a maximum power rating of the engine 10. The maximum power rating of the engine 10 corresponds to the highest power of the engine 10 to avoid damage to the engine 10 and may be set as a guideline by the manufacturer of the engine 10. The maximum power rating of the engine may be a maximum power rating for low altitudes (e.g., altitudes at take-off) and/or a power rating for emergency power (e.g., altitudes for performing take-off maneuvers). The maximum power rating of the engine 10 varies depending on the practical implementation of the engine 10. The predetermined value above the maximum power rating of the engine 10 may be determined by computer simulation or engine testing. The predetermined value may be a percentage above the maximum power rating of the engine 10.

In some embodiments, the maximum fuel flow threshold 330 corresponds to a fuel flow amount to prevent hot section distress on the engine 10. Hot section distress on the engine 10 refers to distress on components (e.g., such as: combustion liner, exit ducts, fuel nozzles, compressor turbine nozzle vanes, compressor turbine blades and/or the like) of the engine 10 that are subject to hot temperatures. The fuel flow amount to prevent hot section distress on the engine 10 may be determined by computer simulation or engine testing. Other techniques for setting the maximum fuel flow threshold 330 are contemplated.

In some embodiments, the fuel schedule 302 may be selected from a plurality of fuel schedules as a function of one or more operating conditions, where each one of the plurality of fuel schedules has a respective fuel flow that varies with the position of the engine control lever. In some embodiments, the method 200 further comprises obtaining one or more operating conditions and selecting the fuel schedule 302 as a function of the obtained one or more operating conditions. By way of a specific and non-limiting example, the method 200 may comprise obtaining an altitude of the aircraft and selecting a fuel schedule based on the altitude of the aircraft. With reference to FIG. 3B, examples of fuel schedules 302₁, 302₂, 302₃, , . . . , 302_{N}, for different altitudes of the aircraft are illustrated. As shown, each one of the fuel schedules 302₁, 302₂, 302₃, , . . . , 302_{N} has a respective fuel flow that varies with the position of the engine control lever. Depending on the current altitude of the aircraft, one of the fuel schedules 302₁, 302₂, 302₃, , . . . , 302_{N}, is selected. For example, at a first range of altitudes, a first fuel schedule 302₁ may be selected and at a second range of altitudes, a second fuel schedule 302₂ may be selected, and so forth. In this example, the first fuel schedule 302₁ corresponds to a lower altitude than the second fuel schedule 302₂ and the second fuel schedule 302₂ corresponds to a lower altitude than a third fuel schedule 302₃, and so forth. As illustrated, the fuel flow of the first fuel schedule 302₁, as a function of a position of the engine control lever, is higher than the fuel flow of the second fuel schedule 302₂, as function of a position of the set power level. The fuel schedules 302₁, 302₂, 302₃, , . . . , 302_{N} may be determined by computer simulation and/or engine testing.

In some embodiments, the fuel schedules 302₁, 302₂, 302₃, , . . . , 302_{N} depend on altitude and at least one additional parameter based on one or more of ambient conditions, operating conditions and engine extractions. For example, the fuel schedules 302₁, 302₂, 302₃, , . . . , 302_{N} illustrated in FIG. 3B may correspond to a set of fuel schedules for a specific range of aircraft speeds. That is, in this example, the set of fuel schedules is selected based on aircraft speed and then from the selected set of fuel schedules a specific fuel schedule is selected based on altitude.

The selection of the fuel schedule 302 from a plurality of fuel schedules may vary depending on practical implementation. For example, altitude and aircraft speed may be used to select a specific fuel schedule from a plurality of fuel schedules. By way of another example, altitude, aircraft speed and engine extractions may be used to select a specific fuel schedule from a plurality of fuel schedules. By way of yet another example, altitude, ambient temperature, aircraft speed and engine extractions may be used to select a specific fuel schedule from a plurality of fuel schedules. In other words, a given fuel schedule may have values that are set as a function of one parameter, two parameters, or three or more parameters.

In some embodiments, selecting the fuel schedule based on one or more operating conditions comprises selecting the maximum fuel flow threshold based on one or more operating conditions. In other words, in some embodiments, when the fuel schedule is selected, the fuel schedule has a maximum fuel flow threshold associated therewith and the maximum fuel flow threshold is selected by virtue of selecting of the fuel schedule.

In some embodiments, the method 200 further comprises detecting the electronic manual override mode of the engine 10. For example, the pilot may manually override the engine 10 into the electronic manual override mode by actuating a switch, a lever, any other suitable mechanism or any other cockpit control. The actuating of the switch, lever, other suitable mechanism or other cockpit control may be detected by monitoring the switch, lever, other suitable mechanism, or via another cockpit control. Once the electronic manual override mode is detected, steps 202, 204 and 206 of method 200 may then be performed. In some embodiments, a control signal is received indicative of the activation of the electronic manual override mode. In response to receipt of the control signal, the method 200 is performed.

In some embodiments, the method 200 further comprises detecting a fault of a control system for controlling the engine 10 and triggering the electronic manual override mode. The fault of the control system for controlling the engine 10 may be a pre-defined fault of the control system such as a failure of operation of the control system. The detecting of the fault of the control system for controlling the engine 10 may be detected based on monitoring the control system 50 or one or more components of the engine 10. Once the electronic manual override mode is triggered, the steps 202, 204 and 206 of method 200 may then be performed. In some embodiments, a control signal is received indicative of the fault of the control system. In response to receipt of the control signal, the electronic manual override mode is triggered and/or method 200 is performed.

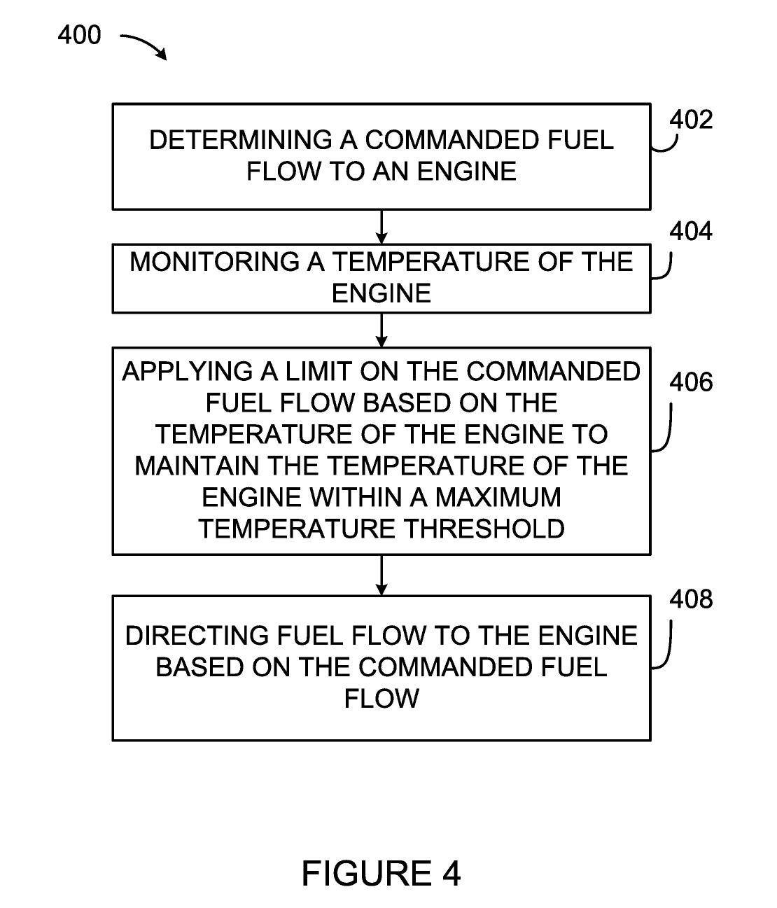

With reference to FIG. 4, there is shown a flowchart illustrating a second example method 400 for directing fuel flow to an engine, such as engine 10 of FIG. 1. While the method 400 is described herein with reference to the engine 10 of FIG. 1, this is for example purposes. The method 400 may be applied to other types of engines depending on practical implementations.

The method 400 is applicable for directing fuel flow to the engine 10 when the engine 10 is in the electronic manual override mode. At step 402, the commanded fuel flow to the engine is determined based on the position of the engine control lever. Step 402 may be implemented in a similar manner as step 202.

At step 404, a temperature of the engine 10 is monitored. The temperature of the engine 10 may be monitored by a temperature measurement device comprising one or more sensors for measuring temperature of the engine 10. The temperature of the engine 10 may be dynamically obtained in real time when needed, or may be obtained periodically in accordance with any predetermined time interval. The temperature of the engine 10 may be actively retrieved, or may be passively received. By way of another example, the temperature of the engine 10 may be retrieved and/or received from a control system or aircraft/engine computer. In some embodiments, the temperature of the engine 10 is obtained via existing components as part of engine control and/or operation. In some embodiments, step 404 comprises triggering measurement of the temperature of the engine 10 whenever method 400 is initiated. The temperature monitored may be the inter turbine temperature (ITT), which is measured between high pressure and low pressure turbines of the engine 10.

At step 406, a limit is applied on the commanded fuel flow based on the temperature of the engine 10 to maintain the temperature of the engine 10 within a maximum temperature threshold. The maximum temperature threshold may be any suitable predetermined threshold based on the implementation on the engine 10. The maximum temperature threshold may correspond to a temperature occurring at the maximum power rating of the engine 10. The maximum temperature threshold may correspond to a temperature to prevent hot section distress on the engine 10. The maximum temperature threshold may be determined based on computer simulations and/or engine testing.

The limit applied to the commanded fuel flow may be determined in any suitable manner depending on the practical implementations. In some embodiments, the limit applied on the commanded fuel flow is determined by use of a control loop. The control loop may use the commanded fuel flow and the temperature of the engine to determine the limit applied on the commanded fuel flow such that the temperature of the engine 10 does not exceed the maximum temperature limit. The control loop may determine the limit applied on the commanded fuel flow in real time when needed, or may be obtained periodically in accordance with any predetermined time interval.

At step 408, fuel flow is directed to the engine based on the commanded fuel flow while maintaining fuel flow within the limit. In other words, fuel flow is directed to the engine 10 based on the commanded fuel flow without exceeding the fuel flow limit. The fuel flow may be direct to the engine 10 by controlling a fuel pump associated with the engine 10.

Similar to method 200, in some embodiments, the method 400 further comprises detecting the electronic manual override mode of the engine 10. Similar to method 200, in some embodiments, the method 400 further comprises detecting a fault of a control system for controlling the engine and triggering the electronic manual override mode.

It should be appreciated that the methods 200, 400 allow for a pilot to directly control the fuel flow to the engine 10 by the engine control lever but limiting the fuel flow to the engine 10, and consequently the power of the engine 10, which may reduce or prevent damage and/or distress on the engine 10.

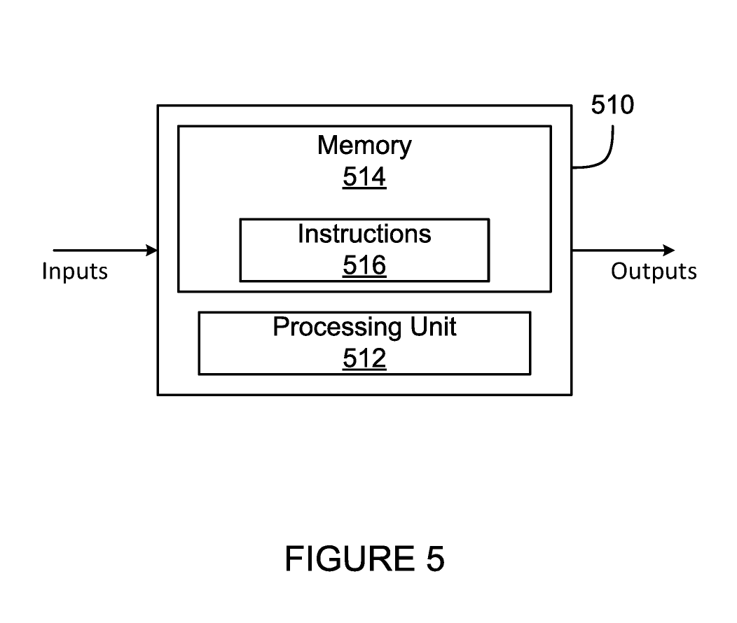

With reference to FIG. 5, the methods 200, 400 may be implemented by a computing device 510, comprising a processing unit 512 and a memory 514 which has stored therein computer-executable instructions 516. The processing unit 512 may comprise any suitable devices configured to implement the system such that instructions 516, when executed by the computing device 510 or other programmable apparatus, may cause the functions/acts/steps of the method 200 as described herein to be executed. The processing unit 512 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 514 may comprise any suitable known or other machine-readable storage medium. The memory 514 may comprise non-transitory computer readable storage medium, for example, but not limited to, an electronic, magnetic, optical, electromagnetic, infrared, or semiconductor system, apparatus, or device, or any suitable combination of the foregoing. The memory 514 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 514 may comprise any storage means (e.g., devices) suitable for retrievably storing machine-readable instructions 516 executable by processing unit 512. In some embodiments, the computing device 510 can be implemented as part of a full-authority digital engine controls (FADEC) or other similar device, including electronic engine control (EEC), engine control unit (EUC), and the like.

The methods and systems for directing fuel flow described herein may be implemented in a high level procedural or object oriented programming or scripting language, or a combination thereof, to communicate with or assist in the operation of a computer system, for example the computing device 510. Alternatively, the methods and systems for directing fuel flow may be implemented in assembly or machine language. The language may be a compiled or interpreted language. Program code for implementing the methods and systems for directing fuel flow may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems for directing fuel flow may also be considered to be implemented by way of a non-transitory computer-readable storage medium having a computer program stored thereon. The computer program may comprise computer-readable instructions which cause a computer, or in some embodiments the processing unit 512 of the computing device 510, to operate in a specific and predefined manner to perform the functions described herein.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

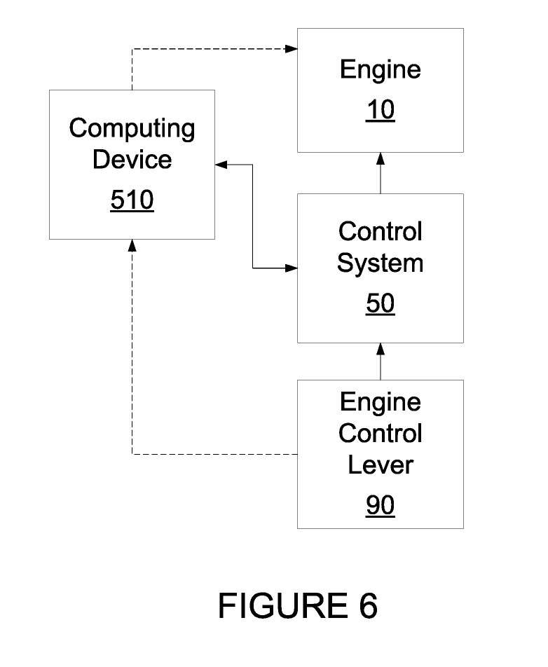

With reference to FIG. 6, a block diagram illustrates the computing device 510 as separate from a control system 50 for controlling the engine 10. The control system 50 may be a full-authority digital engine control (FADEC) or other similar device, including electronic engine control (EEC), engine control unit (EUC), and the like. Accordingly, the computing device 510 upon performance of the method 200 or 400, obtains the set power level of the engine control lever 90. In some embodiments, the set power level may be obtained from the control system 50. In some embodiments, the set power level may be obtained from the engine control lever 90. Where the set power level is obtained therefrom may vary depending on practical implementations and/or an operating state of the control system 50. Indeed, if the control system 50 is in an inoperable state due to failure, the set power level would not be obtained therefrom. The computing device 510 may direct the control system 50 to direct fuel flow to the engine 10. Alternatively, the set power level of the engine control lever 90 may be used by the computing device 510 for directing fuel flow to the engine 10, instead of the control system 50 directing fuel flow of the engine 10. Accordingly, directing fuel flow to the engine 10 may vary depending on practical implementations and/or the operating state of the control system 50. In some embodiments, the computing device 510 may be implemented as part of the control system 50.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure.

Various aspects of the methods and systems for directing fuel flow of an engine of an aircraft may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be obvious to those skilled in the art that changes and modifications may be made without departing from this invention in its broader aspects. The scope of the following claims should not be limited by the embodiments set forth in the examples, but should be given the broadest reasonable interpretation consistent with the description as a whole.

1. A method of directing fuel flow to an engine for an aircraft when the engine is in an electronic manual override mode, the method comprising:
determining a commanded fuel flow to the engine from a fuel schedule based on a position of an engine control lever for controlling the engine;
applying a limit on the commanded fuel flow when the commanded fuel flow exceeds a maximum fuel flow threshold; and
directing fuel flow to the engine based on the commanded fuel flow while maintaining fuel flow within the limit.

2. The method of claim 1, wherein the maximum fuel flow threshold varies as a function of one or more operating conditions.

3. The method of claim 2, wherein the one or more operating conditions comprise one or more of aircraft speed, air temperature, altitude and engine extractions.

4. The method of claim 1, further comprising selecting the fuel schedule based on one or more operating conditions.

5. The method of claim 3, further comprising obtaining an altitude of the aircraft, and wherein selecting the fuel schedule comprises selecting the fuel schedule based on the altitude of the aircraft as the one or more operating conditions.

6. The method of claim 1, wherein the maximum fuel flow threshold corresponds to a fuel flow amount occurring at a predetermined value above a maximum power rating of the engine.

7. The method of claim 1, further comprising detecting the electronic manual override mode of the engine.

8. The method of claim 1, further comprising:
detecting a fault of a control system for controlling the engine; and
triggering the electronic manual override mode.

9. A system for directing fuel flow to an engine for an aircraft when the engine is in an electronic manual override mode, the system comprising:
a processing unit; and
a non-transitory computer-readable memory having stored thereon program instructions executable by the processing unit for:
determining a commanded fuel flow to the engine from a fuel schedule based on a position of an engine control lever for controlling the engine;
applying a limit on the commanded fuel flow when the commanded fuel flow exceeds a maximum fuel flow threshold; and
directing fuel flow to the engine based on the commanded fuel flow while maintaining fuel flow within the limit.

10. The system of claim 9, wherein the maximum fuel flow threshold varies as a function of one or more operating conditions.

11. The system of claim 10, wherein the one or more operating conditions comprise one or more of aircraft speed, air temperature, altitude and engine extractions.

12. The system of claim 9, wherein the program instructions are further executable by the processing unit for selecting the fuel schedule based on one or more operating conditions.

13. The system of claim 12, wherein the program instructions are further executable by the processing unit for obtaining an altitude of the aircraft, and wherein selecting the fuel schedule comprises selecting the fuel schedule based on the altitude of the aircraft as the one or more operating conditions.

14. The system of claim 9, wherein the maximum fuel flow threshold corresponds to a fuel flow amount occurring at a predetermined value above a maximum power rating of the engine.

15. The system of claim 9, wherein the program instructions are further executable by the processing unit for detecting the electronic manual override mode of the engine.

16. The system of claim 9, wherein the program instructions are further executable by the processing unit for:
detecting a fault of a control system for controlling the engine; and
triggering the electronic manual override mode.

17. A method of directing fuel flow to an engine for an aircraft when the engine is in an electronic manual override mode, the method comprising:
determining a commanded fuel flow to the engine based on a position of an engine control lever for controlling the engine;
monitoring a temperature of the engine;
applying a limit on the commanded fuel flow based on the temperature of the engine to maintain the temperature of the engine within a maximum temperature threshold; and
directing fuel flow to the engine based on the commanded fuel flow while maintaining fuel flow within the limit.

18. The method of claim 15, wherein the maximum temperature threshold corresponds to a temperature occurring at a maximum power rating of the engine.

19. The method of claim 17, further comprising detecting the electronic manual override mode of the engine.

20. The method of claim 17, further comprising:
detecting a fault of a control system for controlling the engine; and
triggering the electronic manual override mode.
